(19) United States
(12) Patent Application Publication
(10) Pub. No.: US 2009/0187487 A1
(43) Pub. Date: Jul. 23, 2009

(54) ADVERTISEMENT DISPLAY METHOD

(75) Inventors: Hirohisa Naito, Kawasaki (JP); Takahiro Kii, Kawasaki (JP); Kazumi Kubota, Kawasaki (JP); Akira Miyazaki, Kawasaki (JP); Toru Ozaki, Kawasaki (JP); Masanobu Hatanaka, Kawasaki (JP); Yuji Takahashi, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/359,234

(22) Filed: Jan. 23, 2009

(30) Foreign Application Priority Data
Jan. 23, 2008 (JP) 2008-013057

(51) Int. Cl. G06Q 30/00

(52) U.S. Cl. 705/14

(57) ABSTRACT

An advertisement display method for providing advertisements from a display device, includes acquiring advertisement information which is endowed with an advertisement display right for displaying one or more advertisements, the advertisement information identifies an advertisement displayable by an advertisement display right, deciding whether the advertisement identified by the acquired advertisement information is to be displayed on the display device, on a basis of one or more advertisement points to be consumed by a display of the advertisement on the display device, displaying on the display device, summary data of the identified advertisement once it is decided to be displayed, and displaying detailed data of the identified advertisement on the display device, and consuming the advertisement points of the identified advertisement as displayed, based on a browsing request for details of the advertisement.

### CROSS-REFERENCE TO RELATED APPLICATION

This application is based upon and claims the benefit of priority of the prior Japanese Patent Application No. 2008-013057, filed on Jan. 23, 2008, the entire contents of which are incorporated herein by reference.

### FIELD

Embodiments of the present invention relate to an advertisement display method, an advertisement display system and a recording medium recording an advertisement display program.

### BACKGROUND

Heretofore, there has been an advertisement display device which is installed in a public place for the purpose of advertising shops or commodities. There has been considered, for example, an advertisement display device wherein the displays of the summary data of an advertisement and the detailed data of the advertisement are controlled in accordance with manipulations performed by a user. Incidentally, it is common that advertisement display devices for displaying advertisements are selected at will by an advertiser from among advertisement display devices which are installed in a plurality of places. It is also common that charges for the advertisements which are displayed on the selected advertisement display devices are charged as to the respective advertisement display devices even when the same advertisement has been displayed on these advertisement display devices.

### SUMMARY

At least one embodiment of the present invention provides an advertisement display method for providing advertisements from a display device, includes: acquiring advertisement information which indicates the advertisement displayable by an advertisement display right, from a display right owner terminal which is endowed with the advertisement display right for displaying the advertisement; deciding whether or not the advertisement identified by the acquired advertisement information is to be displayed on the display device, on the basis of (that is, based on) advertisement points of each advertisement as are consumed by a display on the display device; displaying on the display device, summary data of the advertisement which has been decided to be displayed; and displaying detailed data of the advertisement on the display device, and consuming the advertisement points of the displayed advertisement, on the basis of a browsing request for details of the advertisement.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

Embodiments are illustrated by way of example and not limited by the following figures.

FIG. 1 depicts the outline and features of an advertisement display system according to an example of an embodiment of the present invention;

FIG. 2 depicts the outline and other features of an advertisement display system according to an example of an embodiment of the present invention;

FIG. 3 depicts a configuration of an advertisement display system according to an example of an embodiment of the present invention;

FIG. 4 depicts information which is stored in an advertisement point storage unit according to an example of an embodiment of the present invention;

FIG. 5 depicts a flow of an advertisement registration process based on an advertisement display device according to an example of an embodiment of the present invention;

FIG. 6 depicts a flow of an advertisement registration process based on a control device according to an example of an embodiment of the present invention;

FIG. 7 depicts flow of a detailed data display process based on an advertisement display device according to an example of an embodiment of the present invention;

FIG. 8 depicts a flow of an advertisement point consumption process based on a control device according to an example of an embodiment of the present invention;

FIGS. 9A and 9B depict configurations of a portable telephone according to examples of an embodiment of the present invention;

FIG. 10 depicts information which is stored in an individual information storage portion according to an example of an embodiment of the present invention;

FIG. 11 depicts information which is stored in an advertisement ID storage portion according to an example of an embodiment of the present invention;

FIG. 12 depicts a configuration of a management database according to an example of an embodiment of the present invention;

FIG. 13 depicts an example of information which is stored in an advertisement point storage unit according to another example of an embodiment of the present invention;

FIG. 14 depicts information which is stored in a point history storage unit according to another example of an embodiment of the present invention;

FIG. 15 depicts a configuration of an advertisement display device according to another example of an embodiment of the present invention;

FIG. 16 depicts a configuration of an advertisement display device according to another example of an embodiment of the present invention;

FIG. 17 depicts information which is stored in a schedule storage unit according to an example of an embodiment of the present invention;

FIG. 18 depicts information which is stored in a user ID storage unit according to an example of an embodiment of the present invention;

FIG. 19 depicts a process based on a communication process unit according to an example of an embodiment of the present invention;

FIG. 20 depicts information which is stored in a time zone table according to an example of an embodiment of the present invention;

FIG. 21 depicts a process based on a summary data display control unit according to an example of an embodiment of the present invention;

FIG. 22 depicts a process based on a detailed data display control unit according to an example of an embodiment of the present invention;

FIG. 23 depicts a process based on a control device according to another example of an embodiment of the present invention;

FIG. 24 depicts information which is displayed on a display unit of a portable telephone according to an example of an embodiment of the present invention; and

FIG. 25 depicts a computer which runs an advertisement display program according to an example of an embodiment of the present invention.

### DESCRIPTION OF EMBODIMENTS

In the figures, dimensions and/or proportions may be exaggerated for clarity of illustration. It will also be understood that when an element is referred to as being “connected to” another element, it may be directly connected or indirectly connected, i.e., intervening elements may also be present. Further, it will be understood that when an element is referred to as being “between” two elements, it may be the only element layer between the two elements, or one or more intervening elements may also be present. Like reference numerals refer to like elements throughout.

The Related Art technique has had the problem that a high advertisement effect sometimes fails to be attained. More specifically, there is not any method wherein an advertisement effect which is produced when an advertisement is displayed is to be calculated before the display of the advertisement. It has been found that the effect of an advertisement varies with each advertisement display device being used. With the prior-art technique, accordingly, a higher advertisement effect has been sometimes produced when the advertisement is displayed on the advertisement display device installed in a place different from the installation place of the advertisement display device on which the advertisement is usually displayed.

Therefore, as described herein, there is provided an advertisement display method, an advertisement display system and an advertisement display program according to an embodiment of this invention that display the substantially the same advertisement on advertisement display devices installed in a plurality of places, thereby to enhance an expected value for obtaining a high advertisement effect.

Accordingly, there is provided an advertisement display method and system having advertisement display devices that provide advertisements by displaying the summary data of each advertisement and the detailed data of each advertisement on the advertisement display devices. Then, a machine (such as a computer) executes a display propriety decision to decide whether an advertisement uniquely identifiable by advertisement information is to be displayed on the advertisement display devices, on the basis of the advertisement point(s) of each advertisement uniquely identifiable by the advertisement information. These advertisement points are stored in a storage unit and consumed by the display of the advertisement on the advertisement display devices. The consumption of advertisement points occur in cases where the advertisement display devices have acquired the advertisement information indicating the advertisement displayable by an advertisement display right, from a terminal that is possessed by a display right owner endowed with the advertisement display right for displaying the advertisement. The advertisement display method also includes, as executed by the machine, the displaying on the advertisement display devices the summary data of the advertisement that has been decided to be displayed by the display propriety decision; the displaying the detailed data of the advertisement on the advertisement display devices, as a response to a browsing request for the advertisement; and the consumption of the advertisement points stored in the storage unit, as to the advertisement displayed by, at least, either the displaying of the summary data of the advertisement or the displaying of the detailed data of the advertisement.

In one example, the point consumption consumes the advertisement points stored in the storage unit by taking into consideration the consumption magnifications of the advertisement points as are previously set in accordance with, at least, one of a time zone for displaying the advertisement and the sort of the detailed data to be displayed.

In another example, the display propriety decision decides whether the advertisement corresponding to an advertisement ID is to be displayed further on the basis of places where the advertisement display devices are installed.

In yet another example, in a case where it has been decided from the display propriety decision that the advertisement is to be displayed, the machine (such as a computer) is to further execute a display right owner ID storage feature so as to store a display right owner ID for specifying the display right owner, in a storage unit in association with the advertisement information capable of uniquely identifying the advertisement; and a consumption history cumulation feature to cumulate in a storage unit, a consumption history that includes the display right owner ID stored in association with the advertisement in the storage unit and the advertisement points consumed by the point consumption, as to the advertisement displayed by, at least, one of the summary data displaying and the detailed data displaying.

Additionally or alternatively, the consumption history cumulation feature cumulates the consumption history in a case where a browsing request source for the advertisement is not the display right owner.

Additionally or alternatively, there is provided an advertisement display system configured to include advertisement display devices that provide advertisements by displaying the summary data of each advertisement and the detailed data of each advertisement. Each of the advertisement display devices is to include: advertisement point storage component or mechanism to store advertisement points to be consumed by the display of the advertisement on the advertisement display devices, in association with advertisement information capable of uniquely identifying each advertisement; a display propriety decision component or mechanism to decide whether the advertisement uniquely identifiable by the advertisement information is to be displayed on the advertisement display devices, on the basis of the advertisement points stored in the advertisement point storage mechanism, in a case where the advertisement display devices have acquired the advertisement information indicating the advertisement displayable by the advertisement display right, from a terminal displayable by an advertisement display right and/or from a terminal that is possessed by a display right owner endowed with an advertisement display right for displaying the advertisement; a summary data display component or mechanism to display, on the advertisement display devices, the summary data of the advertisement that has been decided to be displayed by the display propriety decision mechanism; a detailed data display component or mechanism to display the detailed data of the advertisement on the advertisement display devices, as a response to a browsing request for the advertisement; and a point consumption component or mechanism to consume the advertisement points stored in the advertisement point storage mechanism, whereby the consumed advertisement points correspond to the advertisement displayed by, at least, one of the summary data display mechanism and the detailed data display mechanism.

Yet in addition, there is provided an advertisement display program in an advertisement display system, the system including at least advertisement display devices. The program causes a computer to execute a process for providing advertisements by displaying the summary data of each advertisement and the detailed data of each advertisement on the advertisement display devices, whereby the machine is to execute the program to: decide whether the advertisement uniquely identifiable by advertisement information is to be displayed on the advertisement display devices, on the basis of advertisement points stored in a storage unit, in a case where the advertisement display devices have acquired the advertisement information indicating the advertisement displayable by an advertisement display right, from a terminal that is possessed by a display right owner endowed with the advertisement display right for displaying the advertisement; display on the advertisement display devices, the summary data of the advertisement that has been decided to be displayed; displaying the detailed data of the advertisement on the advertisement display devices, as a response to a browsing request for the advertisement; and consuming the advertisement points stored in the storage unit, upon the advertisement being displayed by, at least, one of the summary data display and the detailed data display.

According to embodiments of the advertisement display method, advertisement display system and advertisement display program described herein, substantially the same advertisement may be displayed on the advertisement display devices installed in a plurality of places so that an expected value for obtaining a high advertisement effect may be enhanced.

Now, an advertisement display method, advertisement display system and advertisement display program will be described in detail with reference to the accompanying drawings.

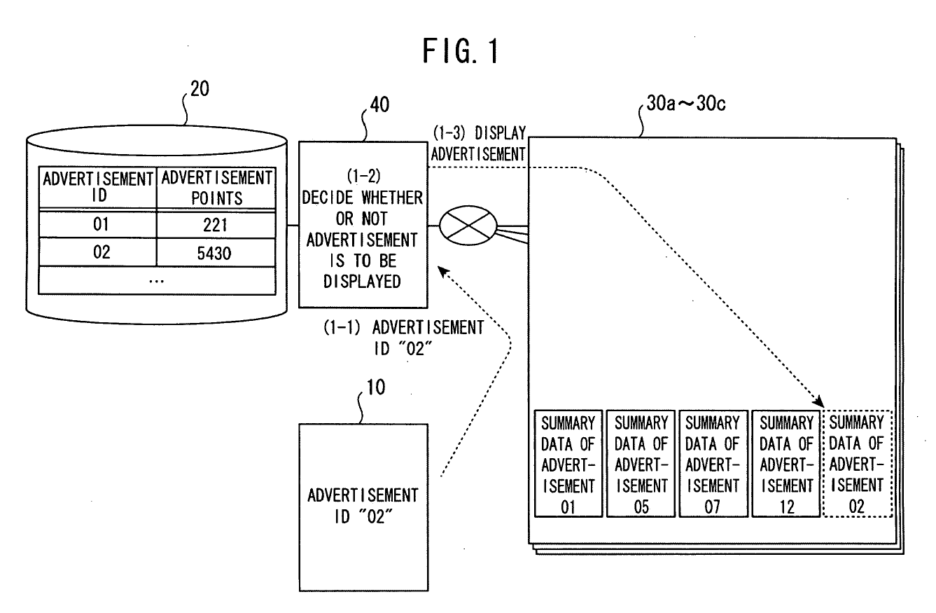

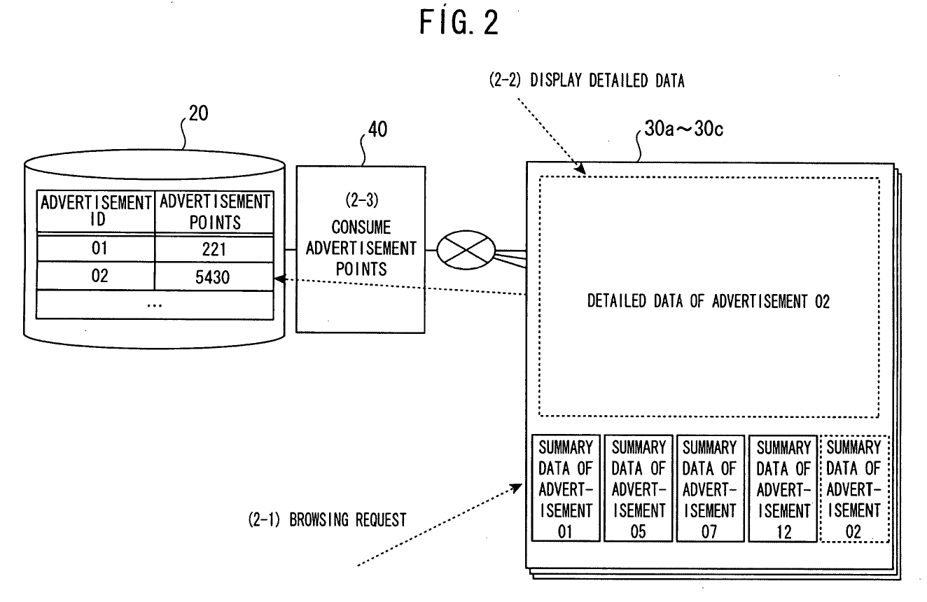

First of all, the outline and features of an advertisement display system are described with reference to FIGS. 1 and 2, which depict the outlines and features of an advertisement display system.

It is the outline of an advertisement display system as described herein that enables an advertisement display device to display summary data with which individual advertisements are uniquely identifiable, and the detailed data of each advertisement, thereby to provide the advertisements, and it is the principal feature thereof that an expected value for obtaining a high advertisement effect is enhanced by displaying substantially the same advertisement on the advertisement display devices which are installed in a plurality of places.

For example, as shown in FIG. 1, an advertisement display system is configured to include a terminal device 10, a management database 20, advertisement display devices 30a-30c installed in a plurality of places, and a control device 40.

Among them, the terminal device 10 is possessed by a display right owner who is endowed with an advertisement display right for displaying an advertisement. As shown in FIG. 1, an advertisement ID which indicates the advertisement displayable by the advertisement display right is stored in the terminal device 10.

As shown in FIGS. 1 and 2, in the management database 20, advertisement points which are consumed with the display controls of the advertisements by the advertisement display devices 30a-30c are retained in association with the advertisement IDs which specify the individual advertisements.

Under such premises, in a case, for example, where the control device 40 has acquired the advertisement ID “02” stored in the terminal device 10, through the advertisement display device 30a as indicated at (1-1) in FIG. 1, it decides whether the advertisement corresponding to the advertisement ID “02” is to be displayed on the advertisement display device 30a, by deciding whether or not utilizable advertisement points remain in the management database 20, as indicated at (1-2) in FIG. 1.

Here, in a case where the control device 40 has decided that the advertisement is to be displayed, it displays the summary data of the advertisement corresponding to the advertisement ID “02”, on the advertisement display device 30a as indicated at (1-3) in FIG. 1.

On the other hand, in a case where the advertisement display device 30a has accepted a browsing request for the advertisement corresponding to the advertisement ID “02”, as indicated at (2-1) in FIG. 2, it responsively displays the detailed data of the advertisement corresponding to the advertisement ID “02”, as indicated at (2-2) in FIG. 2, and it simultaneously requests the control device 40 to consume the advertisement points of the advertisement ID “02”, so as to consume the advertisement points, as indicated at (2-3).

Owing to such a configuration and operations, the advertisement display system is to display the advertisement on the advertisement display devices installed in the plurality of places and may enhance the expected value for obtaining the high advertisement effect, as the principal feature stated before.

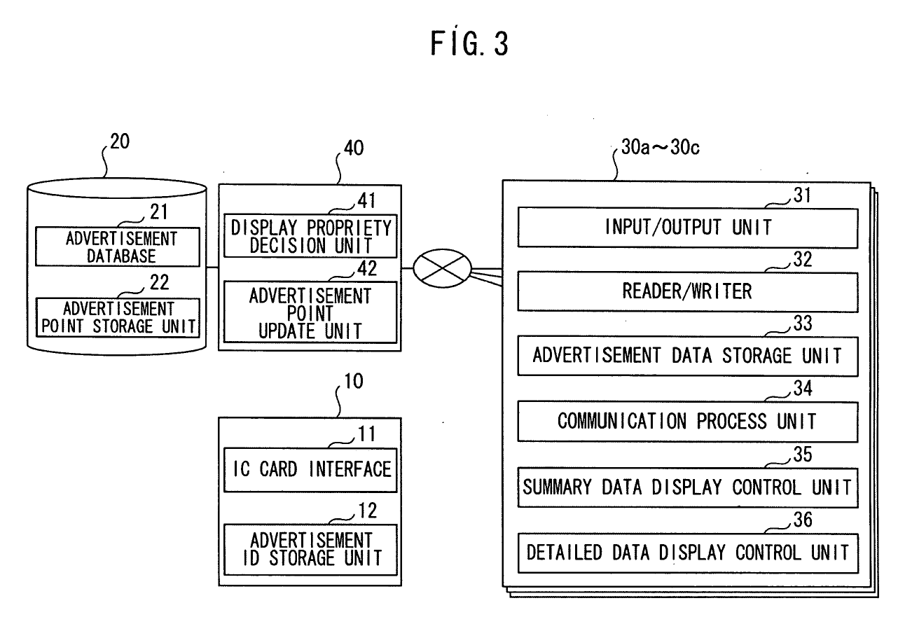

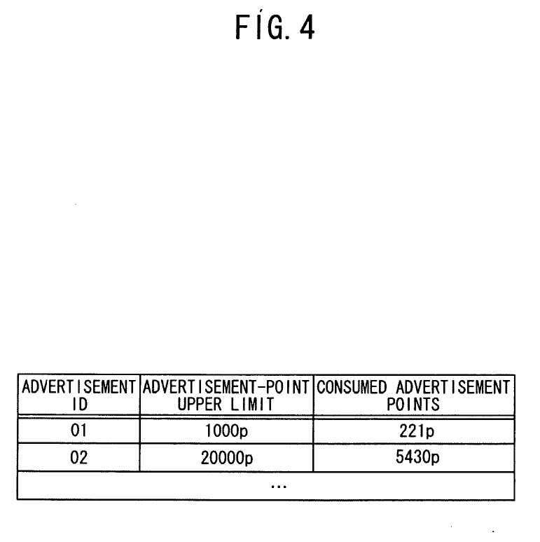

Next, the configuration of the advertisement display system shown in FIGS. 1 and 2 will be described with reference to FIGS. 3 and 4. FIG. 3 depicts a configuration of an advertisement display system. FIG. 4 depicts an example of information which is stored in an advertisement point storage unit. As shown in FIG. 3, the advertisement display system is configured to include the terminal device 10, the management database 20, the advertisement display devices 30a-30c, and the control device 40.

The terminal device 10 is, for example, an IC card or a portable telephone which has an IC card function, and it holds various information items which are exchanged through a reader/writer. Concretely, the terminal device 10 includes an IC card interface 11, and an advertisement ID storage unit 12.

The IC card interface 11 inputs and outputs the information items which are exchanged between this IC card interface and the reader/writer. The advertisement ID storage unit 12 stores therein an advertisement ID which indicates an advertisement displayable by an advertisement display right.

Here, the “advertisement display right” is a right which is bestowed on a user by an advertiser, and with which the advertisement may be displayed on the advertisement display device. The advertisement ID (for example, advertisement ID “02” which indicates the advertisement displayable by the advertisement display right is stored in the terminal which is possessed by the user endowed with the advertisement display right.

The management database 20 stores therein information items for managing individual advertisements, and it includes an advertisement database 21 and the advertisement point storage unit 22 as constituents which are especially closely pertinent to this invention.

The advertisement database 21 stores therein summary data and detailed data which are displayed on the advertisement display devices 30a-30c. Incidentally, the summary data and the detailed data which are stored in the advertisement database 21 are stored when advertisement contracts have been made between the advertisers and an advertisement management enterpriser who manages and operates the advertisements.

The advertisement point storage unit 22 stores therein advertisement points which are consumed with the display controls of the advertisements by the advertisement display devices 30a-30c, in association with advertisement IDs for specifying the respective advertisements. Concretely, as shown in FIG. 4, the advertisement point storage unit 22 stores therein an advertisement-point upper limit and consumed advertisement points in association, every advertisement ID.

Here, the expression “consumed advertisement points” signifies a numerical value which is cumulatively added with the display control of the advertisement. Besides, the expression “advertisement-point upper limit” signifies a threshold value which serves to decide whether or not the advertisement is to be displayed, and as which a numerical value corresponding to accounting is stored when the advertisement contract has been made between the advertisement management enterpriser and the advertiser.

The advertisement display devices 30a-30c are connected in states where they are respectively communicable with the control device 40, and they display and provide advertisements respectively registered therein. Incidentally, the advertisement display devices 30a-30c have substantially the same configurations, each of such devices includes an input/output unit 31, a reader/writer 32, an advertisement data storage unit 33, a communication process unit 34, a summary data display control unit 35 and a detailed data display control unit 36, and they execute substantially the same processes, respectively. Therefore, the individual constituents of the advertisement display device 30a shall be representatively described below.

The input/output unit 31 inputs and outputs various information items. Concretely, the input/output unit 31 is configured including manipulation buttons, a touch panel, a monitor, a display, a loudspeaker, a microphone, or the likes. By way of example, the input/output unit 31 displays summary data capable of uniquely identifying the individual advertisements and the detailed data of each advertisement, and it accepts a browsing request for the advertisement.

The reader/writer 32 inputs and outputs information items which are exchanged between the advertisement display device 30a and the terminal device 10. By way of example, the reader/writer 32 acquires an advertisement ID from the terminal device 10 when this terminal device 10 has been held over the advertisement display device 30a.

The advertisement data storage unit 33 stores therein the summary data and detailed data of the advertisements registered in each of the advertisement display devices 30a-30c. Incidentally, information items stored in the advertisement data storage unit 33 are ones which each of the advertisement display devices 30a-30c has received from the control device 40.

The communication process unit 34 executes the communication processes of information items which are exchanged between the advertisement display device 30a and the control device 40. Concretely, in a case where the communication process unit 34 has acquired the advertisement ID from the terminal device 10, it transmits a registration request that includes the advertisement ID, to the control device 40. Besides, in a case where the communication process unit 34 has accepted a message to the effect that a corresponding advertisement may not be registered, as a response to the registration request, it outputs through the input/output unit 31, a message to the effect that the corresponding advertisement may not be registered.

The summary data display control unit 35 displays the registered summary data. By way of example, the summary data display control unit 35 display-controls the summary data of the individual advertisements stored in the advertisement data storage unit 33.

The detailed data display control unit 36 displays the detailed data of the advertisement as a response to the browsing request for this advertisement. Concretely, in a case where the detailed data display control unit 36 has accepted the advertisement browsing request through the input/output unit 31, it display-controls the detailed data stored in the advertisement data storage unit 33, and it simultaneously transmits a consumption request for advertisement points that includes the advertisement ID of the advertisement whose detailed data have been display-controlled, to the control device 40 through the communication process unit 34.

The control device 40 manages advertisements which are displayed by the advertisement display devices 30a-30c. This control device 40 includes a registration propriety decision unit 41 and an advertisement point update unit 42 as constituents which are especially closely pertinent to this invention.

The registration propriety decision unit 41 decides whether or not the advertisement corresponding to an advertisement ID is to be displayed on the advertisement display devices 30a-30c, on the basis of advertisement points. Concretely, in a case where the registration propriety decision unit 41 has accepted a registration request that includes the advertisement ID, from the advertisement display device 30a, it checks whether or not consumed advertisement points corresponding to the advertisement ID included in a registration request are less than advertisement-point upper limit, with reference to the advertisement point storage unit 22.

Here, in a case where the registration propriety decision unit 41 has decided that the consumed advertisement points are less than the advertisement-point upper limit, it transmits summary data and detailed data corresponding to the advertisement ID included in the registration request, to the advertisement display device 30a so as to store them in the advertisement data storage unit 33.

On the other hand, in a case where the registration propriety decision unit 41 has decided that the consumed advertisement points are, at least, the advertisement-point upper limit, or in a case where the advertisement ID included in the registration request is not stored, this registration propriety decision unit 41 transmits to the advertisement display device 30a, a message to the effect that the advertisement concerning the registration request may not be registered.

The advertisement point update unit 42 consumes the advertisement points. Concretely, in a case where the advertisement point update unit 42 has accepted a consumption request for the advertisement points that includes the advertisement ID, from the advertisement display device 30a, it updates the point information by adding a point (for example, “1p” to the consumed advertisement points stored in the advertisement point storage unit 22.

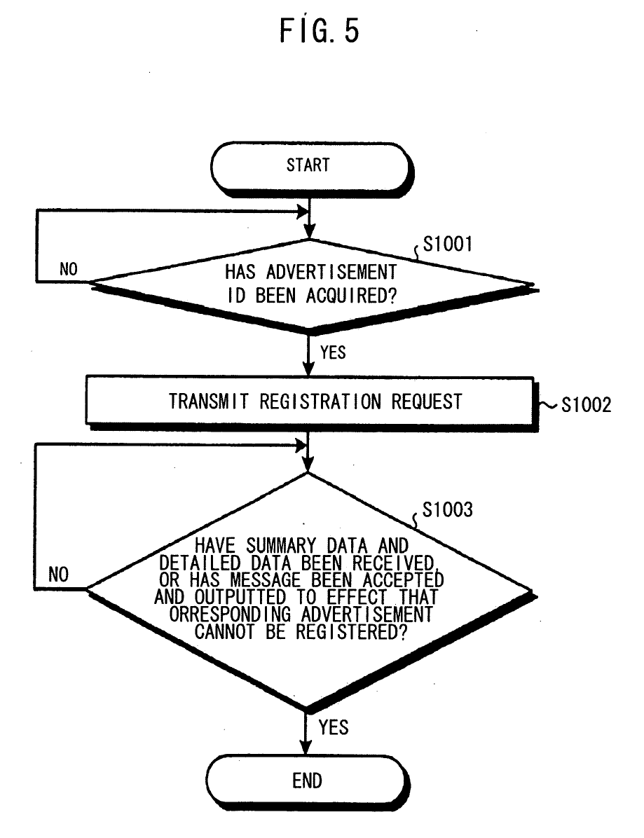

Next, the processes in an advertisement display system will be described with reference to FIGS. 5 to 8, in the order of an advertisement registration process by the advertisement display device 30, an advertisement registration process by the control device 40, a detailed data display process by the advertisement display device 30, and an advertisement point consumption process by the control device 40.

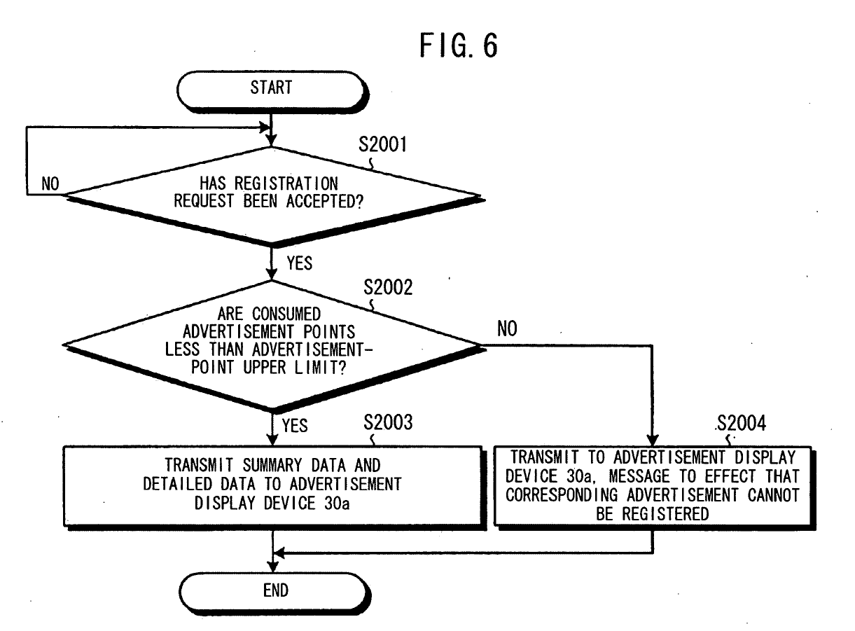

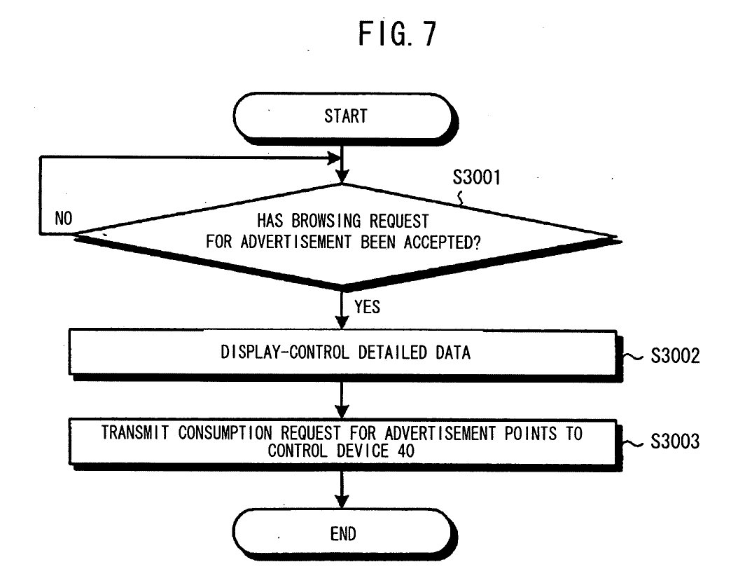

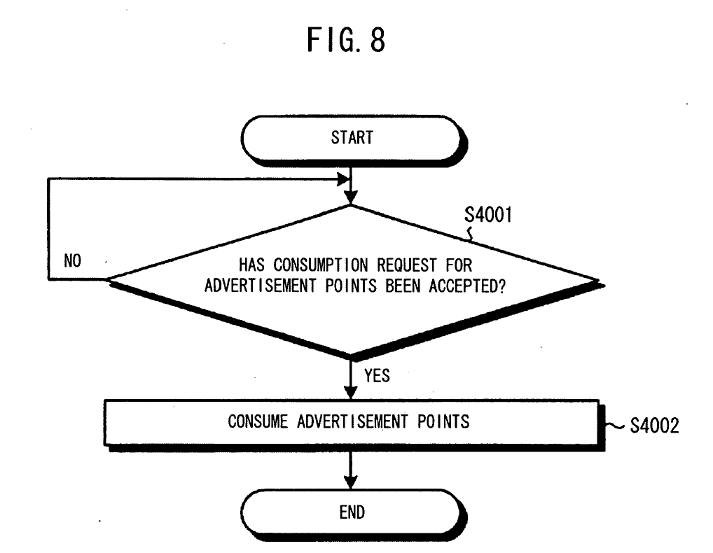

FIG. 5 depicts a flow of an advertisement registration process by a advertisement display device. FIG. 6 depicts an advertisement registration process by a control device. FIG. 7 depicts a detailed data display process by a advertisement display device. FIG. 8 depicts an advertisement point consumption process by the control device.

First, the flow of the advertisement registration process by the advertisement display device 30 will be described with reference to FIG. 5. As shown in FIG. 5, when the advertisement display device 30 acquires an advertisement ID from the terminal device 10 (at S1001: “Yes”, the advertisement display device 30 transmits a registration request that includes the advertisement ID, to the control device 40 (at S1002).

Thereafter, the advertisement display device 30 ends the advertisement registration process in a case where it has received summary data and detailed data corresponding to the advertisement ID included in the registration request, from the control device 40 and has stored them in the advertisement data storage unit 33, or where it has accepted and outputted a message to the effect that a corresponding advertisement may not be registered, as a response to the registration request (at S1003: “Yes”.

Next, the flow of the advertisement registration process by the control device 40 will be described with reference to FIG. 6. As shown in FIG. 6, when the control device 40 accepts a registration request that includes an advertisement ID, from the advertisement display device 30a (at S2001: “Yes”, the control device 40 checks whether or not consumed advertisement points corresponding to the advertisement ID included in the registration request are less than an advertisement-point upper limit (at S2002).

Here, in a case where the control device 40 has decided that the consumed advertisement points are less than the advertisement-point upper limit (at S2002: “Yes”, the control device 40 transmits summary data and detailed data corresponding to the advertisement ID included in the registration request, to the advertisement display device 30a (at S2003), and it ends the advertisement registration process.

On the other hand, in a case where the control device 40 has decided that the consumed advertisement points are, at least, the advertisement-point upper limit, or in a case where the advertisement ID included in the registration request is not stored (at S2002: “No”, the control device 40 transmits to the advertisement display device 30a, a message to the effect that an advertisement concerning the registration request cannot be registered (at S2004), and it ends the advertisement registration process.

Next, the flow of the detailed data display process by the advertisement display device 30 will be described with reference to FIG. 7. As shown in FIG. 7, when the advertisement display device 30 accepts a browsing request for an advertisement (at S3001: “Yes”, the advertisement display device 30 display-controls detailed data (at S3002).

Subsequently, the advertisement display device 30 transmits a consumption request for advertisement points that includes an advertisement ID, to the control device 40 (at S3003), and it ends the detailed data display process.

Next, the advertisement point consumption process by the control device 40 will be described with reference to FIG. 8. As shown in FIG. 8, when the control device 40 accepts a consumption request for advertisement points that includes an advertisement ID, from the advertisement display device 30a (at S4001: “Yes”, it consumes the advertisement points (step S4002), and it ends the advertisement point consumption process.

As described above, substantially the same advertisement may be displayed on the advertisement display devices installed in a plurality of places, so that an expected value for obtaining a high advertisement effect may be enhanced. By way of example, in a case where the summary data of an advertisement are displayed by the plurality of advertisement display devices, a possibility at which the advertisement is to be browsed may be heightened, and the expected value for obtaining the high advertisement effect may be enhanced.

Also, an advertisement display in an effective place may be expected through an advertisement displayer while the total advertisement cost is held.

Further, an advertisement management enterpriser who manages advertisements may collect charges from advertisers in correspondence with browsing requests for the advertisements. Accordingly, the advertisement management enterpriser may omit the labor of setting accounting which corresponds to the places where the advertisement display devices are installed, and that he/she may set the accounting which corresponds to the advertisement effect.

Still further, the advertiser may omit the labor of making investigation beforehand in order to seek the advertisement display device which may attain a higher advertisement effect.

In the ensuing description, a user who is endowed with an advertisement display right shall be expressed as an “advertisement mediator”, while a user who browses an advertisement shall be expressed as an “advertisement browser (browsing person)”.

According to another embodiment, there is provided an advertisement display system configured to include a terminal device 10, a management database 20, advertisement display devices 30a-30c, and a control device 40, likewise to a advertisement display system described earlier.

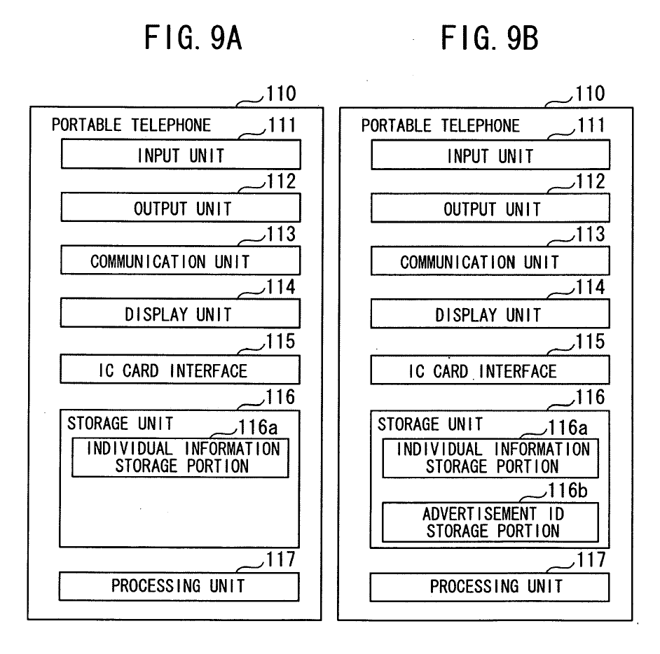

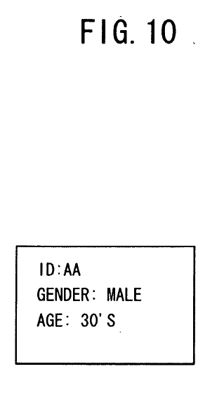

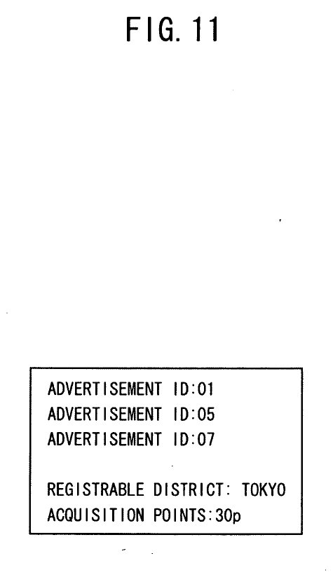

In one example, the terminal device 10 as applied to a portable telephone 110 will be described with reference to FIGS. 9A to 11. FIGS. 9A and 9B depict configurations of the portable telephone. FIG. 10 depicts information which is stored in an individual information storage portion. FIG. 11 depicts an example of information which is stored in an advertisement ID storage portion.

As shown in each of FIGS. 9A and 9B, the portable telephone 110 being the terminal device 10 is configured including an input unit 111, an output unit 112, a communication unit 113, a display unit 114, an IC card interface 115, a storage unit 116, and a processing unit 117.

The input unit 111 is configured including manipulation buttons, a microphone, etc., and it inputs various information items. Besides, the output unit 112 is configured including a loudspeaker, etc., and it outputs various information items. In addition, the communication unit 113 performs a telephone function.

The display unit 114 is configured including a monitor, a display, etc., and it displays various information items. Besides, the IC card interface 115 inputs and outputs information items which are exchanged between the portable telephone 110 and a reader/writer.

The storage unit 116 stores therein data and programs which are used to implement various processes based on the processing unit 117. For example, as shown in FIG. 9A, the portable telephone 110 possessed by an advertisement browser (browsing person) is configured including the individual information storage portion 116a, and as shown in FIG. 9B, the portable telephone 110 possessed by an advertisement mediator is configured to include the individual information storage portion 116a and the advertisement ID storage portion 116b.

As shown in FIG. 10, the individual information storage portion 116a stores therein individual information items such as a user ID, a gender and an age. Besides, as shown in FIG. 11, the advertisement ID storage portion 116b stores therein advertisement IDs, a registrable district which indicates a place where advertisements may be displayed, and acquisition points. Here, the “acquisition points” are points which are used for restoring part of a profit that the advertiser has gained by displaying the advertisement, for an act in which the advertisement mediator has displayed the advertisement on the advertisement display device.

The processing unit 117 has an internal memory which serves to store therein an OS (Operating System) and the like control programs, programs prescribing various processing procedures, and required data, and it executes various processes by using them. Concretely, the processing unit 117 reads and writes the information items stored in the storage unit 116, and it display-controls the information items on the display unit 114.

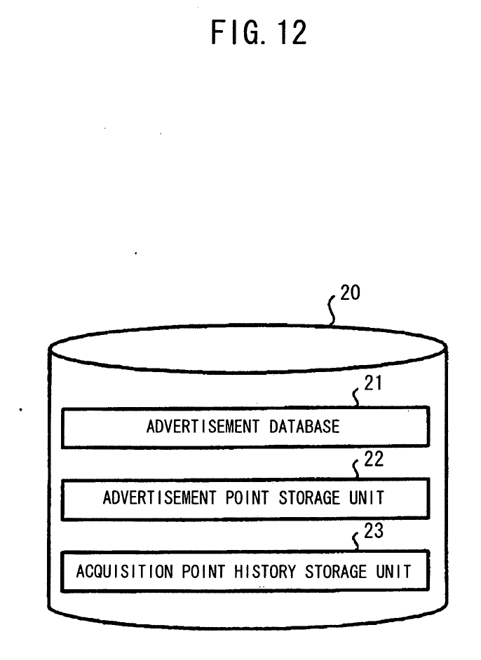

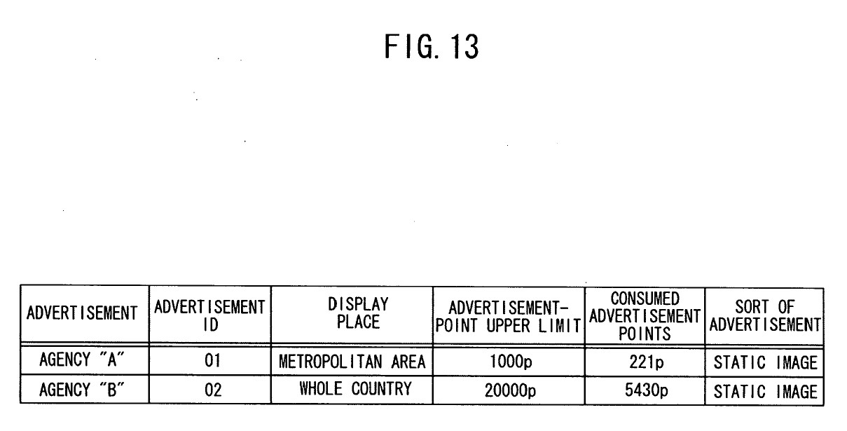

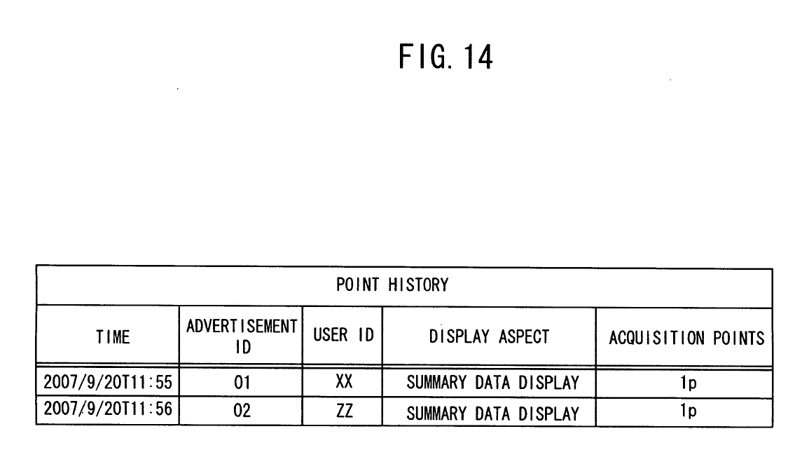

Next, the configuration of the management database 20 will be described with reference to FIGS. 12 to 14. FIG. 12 depicts a configuration of the management database according to one example. FIG. 13 is a diagram showing an example of information which is stored in an advertisement point storage unit. FIG. 14 is a diagram showing an example of information which is stored in a point history storage unit.

As shown in FIG. 12, here the management database 20 further includes the point history storage unit 23 and other feature(s) as explained below.

As shown in FIG. 13, the advertisement point storage unit 22 stores therein an advertisement ID, a display place, an advertisement-point upper limit, consumed advertisement points, and the sort of an advertisement, in association and every advertiser. Here, the “display place” is information for limiting a place where the advertisement is displayed.

As shown in FIG. 14, the point history storage unit 23 stores therein a point history in which a time, an advertisement ID, a user ID, a display aspect, and acquisition points are held in association.

Here, the “time” denotes the time at which a corresponding display history was stored, and the “display aspect” denotes the display aspect in which a corresponding advertisement was displayed on the respective advertisement display devices 30a-30c.

(Advertisement Display device)

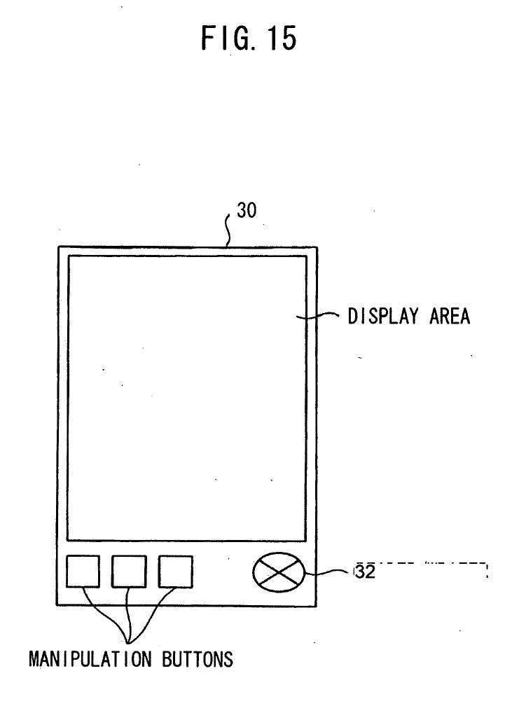

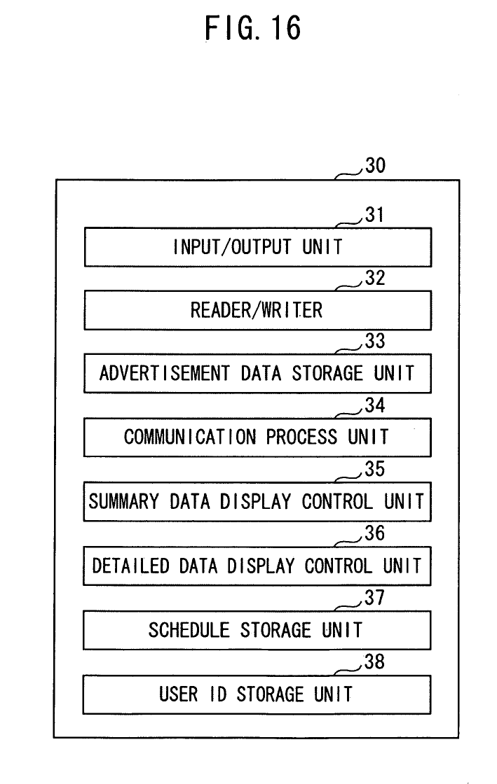

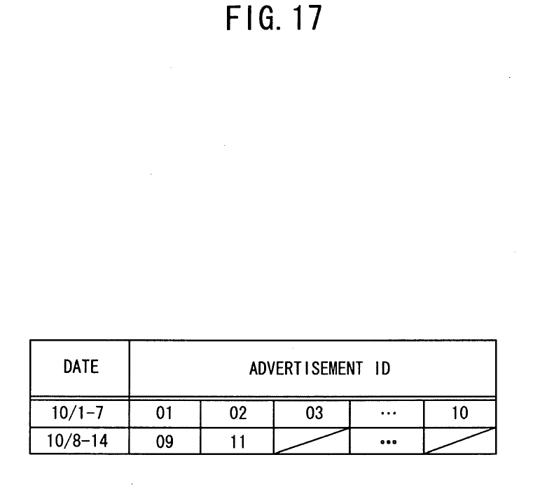

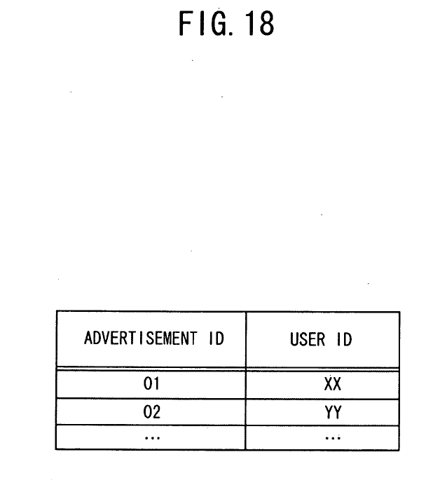

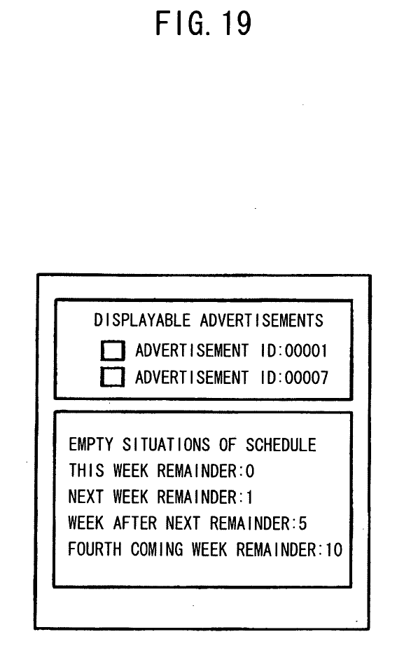

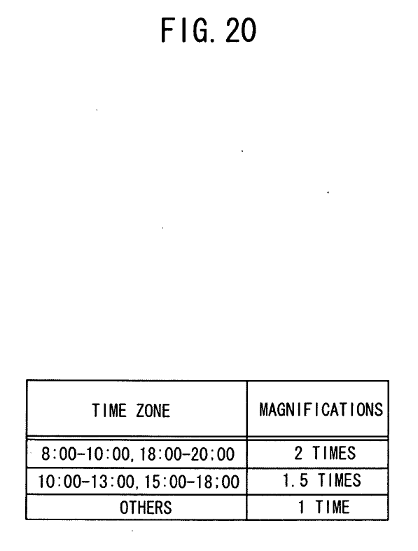

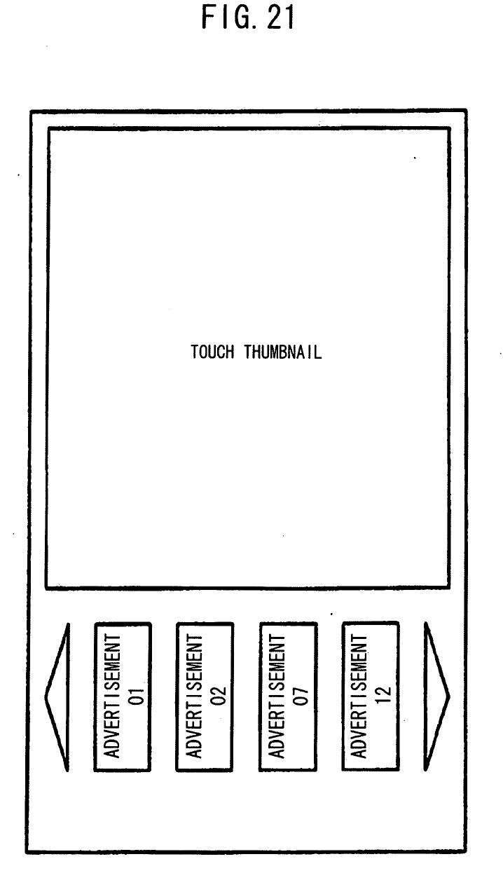

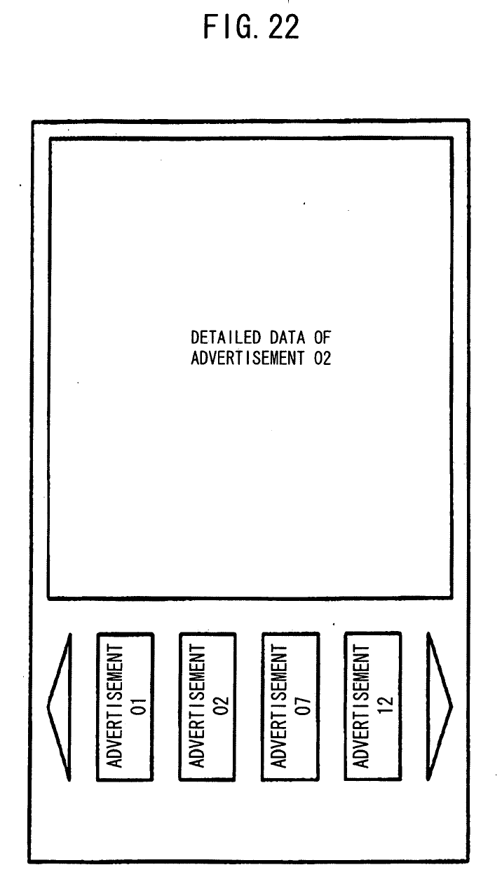

Next, the configuration of the advertisement display device 30a (30b or 30c) will be described with reference to FIGS. 15 to 22. FIG. 15 depicts a configuration of the advertisement display device. FIG. 16 depicts a configuration of the advertisement display device according to this embodiment. FIG. 17 depicts an example of information which is stored in a schedule storage unit. FIG. 18 depicts an example of information which is stored in a user ID storage unit. FIG. 19 depicts a process based on a communication process unit. FIG. 20 depicts an example of information which is stored in a time zone table. FIG. 21 depicts a process based on a summary data display control unit. FIG. 22 is a diagram for explaining a process based on a detailed data display control unit.

The advertisement display device 30a will be described as including a display area of touch panel type, individual manipulation buttons and a reader/writer 32 as shown in FIG. 15. Here, the advertisement display device 30a further includes the schedule storage unit 37 and the user ID storage unit 38 as shown in FIG. 16, and in points to be explained below.

As shown in FIG. 17, the schedule storage unit 37 stores therein the advertisement ID of each advertisement which is to be displayed on corresponding days, in association with the date. Incidentally, an oblique line indicated in FIG. 17 signifies that any information is not stored. Besides, as shown in FIG. 18, the user ID storage unit 38 stores therein a user ID in association with the advertisement ID.

When the portable telephone 110 is held over the reader/writer 32 by the advertisement mediator, the communication process unit 34 displays the advertisement IDs of registrable advertisements and the empty situations of a schedule on the portable telephone 110 as shown in FIG. 19, with reference to the schedule storage unit 37.

Thereafter, when the portable telephone 110 is held over the reader/writer 32 by the advertisement mediator again in a state where the advertisement ID of the advertisement to be registered is selected, the communication process unit 34 acquires the user ID, the selected advertisement ID and the registrable district from the portable telephone 110. In addition, on condition that the place where the advertisement display device 30a is installed is included in the registrable district, the communication process unit 34 transmits a registration request that includes the user ID and the selected advertisement ID, to the control device 40.

Thereafter, in a case where summary data and detailed data have been stored in an advertisement data storage unit 33, the communication process unit 34 stores the advertisement ID of the stored advertisement in the schedule storage unit 37 in association with the date, and it simultaneously stores the user ID in the user ID storage unit 38 in association with the advertisement ID of the stored advertisement.

In a case where the summary data display control unit 35 has not accepted any manipulation by the advertisement browser, it displays the summary data corresponding to each advertisement ID and the digest of the detailed data on the whole display area while replacing them every fixed time period, in accordance with the information items stored in the schedule storage unit 37, and it simultaneously transmits a consumption request for the advertisement points that includes the advertisement ID of the displayed advertisement and the user ID stored in the user ID storage unit 38 in association with this advertisement ID, to the control device 40 through the communication process unit 34, so as to consume the advertisement points by “1p”.

A time zone table in which a time zone and magnifications are associated as shown in FIG. 20 may be further stored, whereby the summary data display control unit 35 consumes the advertisement points by taking into consideration the time zone in which the summary data or the digest of the detailed data were/was displayed, as the consumption magnifications of the advertisement points.

Besides, when the portable telephone 110 is held over the reader/writer 32 by the advertisement browser, the summary data display control unit 35 acquires the user ID from the portable telephone 110, and it simultaneously outputs and displays the thumbnail of each advertisement and a manipulation method on the display area (refer to FIG. 21).

In a case where the thumbnail of each advertisement has been pushed by the advertisement browser, the detailed data display control unit 36 display-controls the detailed data (refer to FIG. 22), and it simultaneously transmits a consumption request for the advertisement points that includes the advertisement ID whose detailed data were displayed, and the user ID which is stored in the user ID storage unit 38 in association with this advertisement ID, to the control device 40 through the communication process unit 34, so as to consume the advertisement points by “5p”.

Besides, in a case where a display area which is included in the detailed data and which means “coupon ticket issue” is pushed by the advertisement browser, the detailed data display control unit 36 issues a coupon ticket, and it simultaneously transmits a consumption request for the advertisement points that includes the advertisement ID of the advertisement for which the coupon ticket was issued, and the user ID which is stored in the user ID storage unit 38 in association with this advertisement ID, to the control device 40 through the communication process unit 34, thereby to make the request for the consumption of the advertisement points by “10p”.

Incidentally, the advertisement points may be consumed by taking into consideration the time zone in which the detailed data were displayed or in which the coupon ticket was issued, as the consumption magnifications of the advertisement points. Alternatively, the advertisement points may be consumed in accordance with the advertisement browsing time period of the advertisement browser. Besides, in a case where the user ID stored in the user ID storage unit 38 in association with the advertisement ID of the advertisement whose detailed data were displayed agrees with the user ID acquired by the summary data display control unit 35, the transmission of the consumption request for the advertisement points may be suspended. Further, once the points of the manipulated advertisement have occurred, any point for substantially the same advertisement may be prevented from occurring for a fixed time period (for example, 5 minutes). This is intended to make continuous advertisement point gaining difficult.

Next, the configuration of the control device 40 will be described. Here, the control device 40 according to this embodiment differs from the control device 40 according to the foregoing embodiment, in points to be explained below.

When the registration propriety decision unit 41 accepts a registration request that includes a user ID and an advertisement ID, it transmits summary data and detailed data corresponding to the advertisement ID included in the registration request, to the advertisement display device 30a so as to store them in the advertisement data storage unit 33, on conditions that consumed advertisement points corresponding to the advertisement ID included in the registration request are less than an advertisement-point upper limit, by referring to the advertisement point storage unit 22, and that a place where the advertisement display device 30a being a transmission source is installed is included in a display place corresponding to the advertisement ID included in the registration request.

In a case where the advertisement point update unit 42 has accepted a consumption request for advertisement points that includes an advertisement ID and a user ID, from the advertisement display device 30a, it adds points to the consumed advertisement points stored in the advertisement point storage unit 22 in association with the advertisement ID included in the consumption request for the advertisement points, thereby to update the consumed advertisement points, and it simultaneously stores a new point history in the point history storage unit 23.

As described above, a charge corresponding to an advertisement effect may be set in more detail. By way of example, when a coupon ticket was issued, advertisement points which are more than in a case where an advertisement was browsed are consumed, and hence, a larger charge may be collected for the issue of the coupon ticket as is considered to produce a higher advertisement effect. For an advertiser, a larger expense has been allotted to the advertisement act of the higher effect.

Also, it is possible to reduce the risk that an advertisement which produces an advertisement effect in only a specified district will be displayed in a district in which the advertisement effect is not produced, so advertisement points will be wastefully consumed.

Further, a profit obtained by displaying an advertisement may be restored to an advertisement mediator. As a result, when the advertiser offers premiums corresponding to acquisition points, the act of the advertisement mediator for registering advertisements is considered to be promoted, and the advertisements may be provided in more places.

Still further, it is possible to prevent the act of the advertisement mediator for browsing his/her registered advertisement by himself/herself. More specifically, by way of example, there is the possibility that the advertisement mediator will browse his/her advertisement by himself/herself so as to gain acquisition points, with the aim of obtaining a premium corresponding to the acquisition points. However, the acquisition points are cumulated in a case where the browsing request source of the advertisement is not the advertisement mediator. Therefore, the act of gaining the acquisition points may be prevented.

In another example, a method for storing summary data and detailed data in the advertisement data storage unit 33 may be such that an advertiser accesses a Web page which is managed by an advertisement management enterpriser, thereby to store the summary data and the detailed data.

Also, regarding a method for setting accounting for advertisements, and a method for collecting charges which an advertisement management enterpriser collects from advertisers, by way of example, the accounting setting in the case of advertising in only the metropolitan area and the accounting setting in the case of advertising in the whole country may be made different. Besides, a premium which the advertiser offers may be collected as the charge.

In addition, the valid term of an advertisement may be set. Hence, an advertiser may display the advertisement only when he/she wants to display the advertisement. For example, the valid term is further stored in association with an advertisement ID in the advertisement point storage unit 22. When the valid term has lapsed, the control device 40 may command each of the advertisement display devices 30a-30c to delete summary data and detailed data stored in the advertisement data storage unit 33.

Further, regarding a method for setting display places where advertisements are displayed, by way of example, the display places may be set so that the advertisements may be displayed only in public facilities which exist in the metropolitan area.

The place conditions of the display places may be expressed by several indices so as to compare the places. By way of example, it is considered to use the two indices of a positional genre which represents the attributes of the places (for example, a road, a station, the interior of a store, and the public facilities), and an area which represents physical ranges (for example, the whole country, the metropolitan area, within Tokyo, and within Shinjuku-ku). In this case, advertisement data and an advertisement mediator may be permitted to set the indices at will. By way of example, either or both of the indices may be set, or the indices are in default (that is, the advertisements are displayable anywhere). Also, a plurality of items may be designated as to the positional genre.

Further, the place conditions may be expressed by the several indices so as to compare the places. By way of example, in the place designation of the advertisement display device (for example, UBWALL (registered trademark)), which of the items the advertisement display device corresponds to may be set as to the positional genre. The area may be decided depending upon if the installation place of the advertisement display device is included in the area condition.

Still further, regarding a method for storing an advertisement ID in the terminal device 10 or the portable telephone 110, any of an advertisement management enterpriser, an advertiser and an advertisement mediator may well store the advertisement ID. By way of example, when the advertisement mediator has purchased a commodity sold by the advertiser, the advertiser may well store the advertisement ID in the portable terminal 10 possessed by the advertisement mediator, and the advertisement mediator may well acquire and store the advertisement ID on the basis of the information of a coupon or the like which is offered by the advertisement management enterpriser or the advertiser.

Yet further, in storing an advertisement ID in the portable terminal 10, summary data and detailed data may be further stored, and the summary data and the detailed data may be stored instead of the advertisement ID.

In addition, regarding a method for storing summary data and detailed data in the advertisement data storage unit 33, each of the advertisement display devices 30a-30c may well load the summary data and the detailed data from the advertisement database 21 through the control device 40 and then store them in the advertisement data storage unit 33.

Still in addition, a process for checking whether or not consumed advertisement points corresponding to an advertisement ID in a registration request are less than an advertisement-point upper limit may be executed by each of the advertisement display devices 30a-30c. As a concrete example, each of the advertisement display devices 30a-30c may well store the consumed advertisement points and the advertisement-point upper limit as a batch, so as to check the consumed advertisement points.

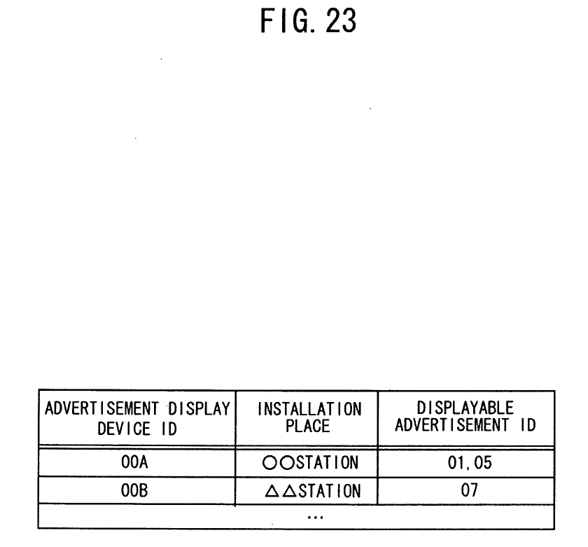

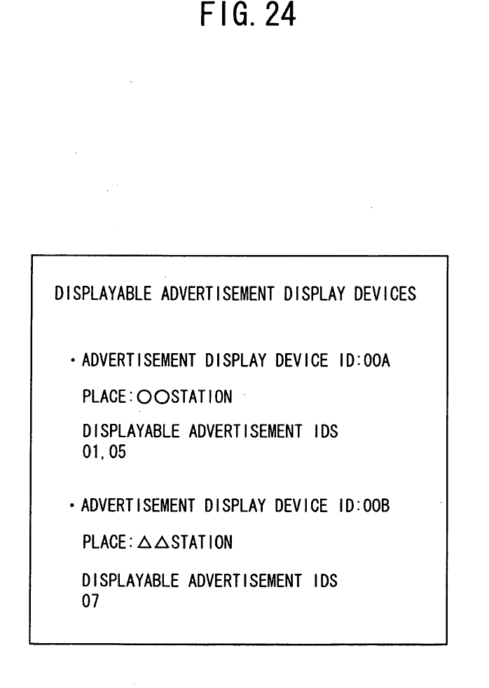

Yet in addition, in outputting a message to the effect that an advertisement may not be displayed, the place of the advertisement display device which may display the advertisement may be notified to an advertisement mediator. As a concrete example, the control device 40 may well store the advertisement IDs of displayable advertisements for the respective advertisement display devices (refer to FIG. 23), or places where advertisements can be displayed may be displayed on the portable telephone 110 through each of the advertisement display devices 30a-30c (refer to FIG. 24).

Incidentally, FIG. 23 is a diagram for explaining a process based on the control device. Besides, FIG. 24 is a diagram showing an example of information which is displayed on the display unit of the portable telephone.

Each advertiser may be permitted to check on occasion, information which is stored in the advertisement point storage unit 22, and an alarm may be issued when consumed advertisement points have approached an advertisement-point upper limit.

Besides, as a process for preventing an act for gaining acquisition points, a process for forming a new point history in the history storage unit 23 may be suspended in a case where a browsing request for an advertisement has been accepted in a fixed time period (for example, in 5 minutes) since the portable telephone 110 had been held over the reader/writer 32 by an advertisement mediator.

Further, in a case where the portable telephone 110 has been held over the reader/writer 32 by an advertisement browser, the summary data of individual advertisements may be listed up and then outputted and displayed.

Still further, in a case where consumed advertisement points have arrived at an advertisement-point upper limit, the summary data and detailed data of an advertisement as are stored in the advertisement data storage unit 33 of each of the advertisement display devices 30a-30c may be deleted.

Yet further, the case of consuming advertisement points each time detailed data are displayed has been described in each of the foregoing embodiments, but the advertisement points may be collectively consumed after the advertisement points to be consumed have been managed for a fixed time period in each of the advertisement display devices 30a-30c.

In addition, the case where points are cumulatively added to consumed advertisement points with the display control of an advertisement has been described in each of the foregoing embodiments. However, a consumption process for advertisement points is not restricted to the above case, but it may be, for example, such that the utilizable advertisement points are stored in the storage unit when an advertisement contract has been made between an advertisement management enterpriser and an advertiser, and that the advertisement points are thereafter consumed so as to be decreased with the display control of the advertisement.

Still in addition, information items which include the processing procedures, control procedures, concrete appellations, and various data and parameters indicated in the above description and the drawings (for example, the stored information items shown in FIG. 4, FIG. 13, FIG. 14, FIG. 20 and FIG. 23, and the display examples shown in FIG. 10, FIG. 11, FIG. 19, FIG. 21, FIG. 22 and FIG. 24) may be altered at will unless specially mentioned.

Yet in addition, the respective constituents of the various illustrated devices are indicated as functional concepts, and they need not be physically configured as illustrated. That is, feature(s) of the disintegrations and integrations of the various devices are not restricted to the illustrated ones, but the whole or part of each of the devices may be functionally or physically disintegrated or integrated in arbitrary units, in accordance with various loads, the situations of uses, etc. By way of example, the summary data display control unit 35 and the detailed data display control unit 36 shown in FIG. 3 may be integrated and configured.

Further, all or any desired ones of individual processing functions which are fulfilled by the various devices may be realized by a CPU and one or more software programs which are analyzed and run by the CPU, or they may be realized as hardware based on wired logic.

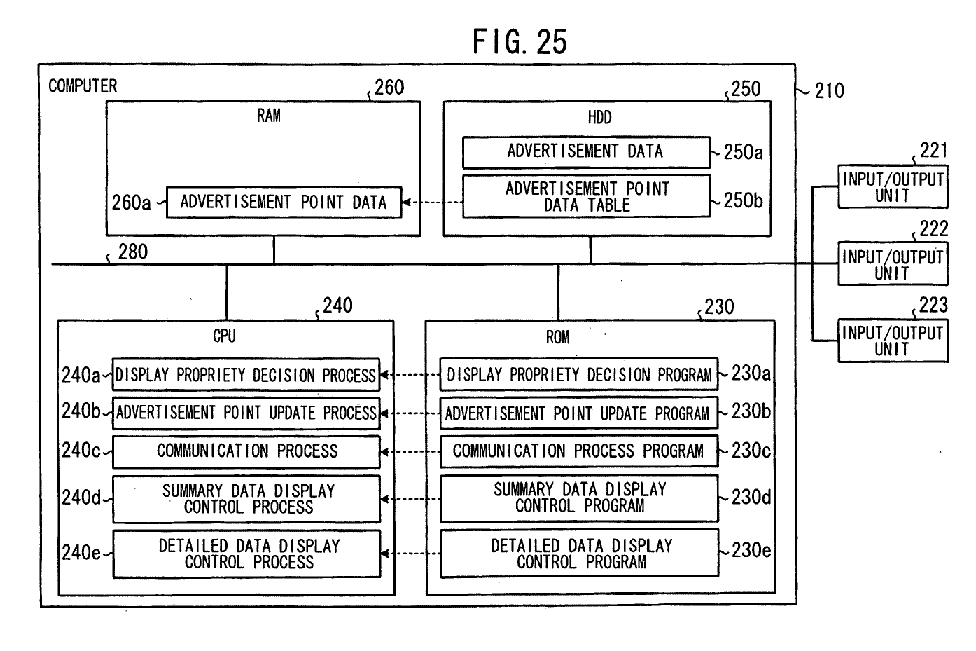

Meanwhile, embodiments of the present invention may be incarnated in such a way that programs prepared beforehand are run by a computer which operates as an advertisement display system. Therefore, the computer which runs an advertisement display program having the substantially the same functions as those of the advertisement display system stated in each of the foregoing embodiments will now be described as an example with reference to FIG. 25. FIG. 25 depicts a computer which runs an advertisement display program.

As shown in the figure, the computer 210 operating as the advertisement display system is configured in such a way that display units 221-223, a ROM 230, a CPU 240, an HDD 250 and a RAM 260 are connected by a bus 280, etc.

The advertisement display programs which implement substantially the same functions as those of the advertisement display system stated in one or more of the foregoing embodiments, for example, a display propriety decision program 230a, an advertisement point update program 230b, a communication process program 230c, a summary data display control program 230d and a detailed data display control program 230e, is/are stored in the ROM 230 beforehand. The programs 230a-230e may be appropriately integrated or disintegrated likewise to the respective constituents of the advertisement display system shown in FIG. 3.

In addition, the CPU 240 fetches the programs 230a-230e from the ROM 230 and runs them, whereby the programs 230a-230e function as a display propriety decision process 240a, an advertisement point update process 240b, a communication process 240c, a summary data display control process 240d and a detailed data display control process 240e as shown in FIG. 25. Incidentally, the processes 240a-240e correspond respectively to the display propriety decision unit 41, the advertisement point update unit 42, the communication process unit 34, the summary data display control unit 35 and the detailed data display control unit 36 shown in FIG. 3.

Besides, advertisement data 250a and an advertisement point data table 250b are installed in the HDD 250 as shown in FIG. 25.

In addition, the CPU 240 fetches advertisement point data 260a from the advertisement point data table 250b and stores them in the RAM 260, and it executes a process on the basis of the advertisement point data 260a stored in the RAM 260.

The advertisement point data 260a corresponds to the advertisement point storage unit 41 shown in FIG. 3.

It should be understood that the individual programs 230a-230e need not be stored in the ROM 230 from the beginning. By way of example, the programs may be stored in a “portable physical medium” such as a flexible disk (FD), a CD-ROM, a DVD disk, a magneto-optic (MO) disk or an integrated circuit (IC) card which is inserted into the computer 210, or a “fixed physical medium” such as an HDD which is disposed inside or outside the computer 210. Further, the programs may be stored in “another computer (or server)” or the like which is connected to the computer 210 through a public network, the Internet, a LAN, a WAN or the like. Thus, the computer 210 may well fetch the stored programs and run them.

The advertisement display method as described in various embodiments and their examples above may be incarnated in such a way that a software program prepared beforehand is run by a machine, such as a personal computer or a workstation. The software program may be distributed through a data network such as the Internet or an intranet. Further, the software program may be recorded or encoded in a computer-readable record medium such as a hard disk, a flexible disk (FD), a CD-ROM, an MO or a DVD and be fetched from the record medium and run by the computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments, and examples thereof, of the present inventions have been described in detail, it should be understood that the various changes, substitutions, and alterations may be made hereto without departing from the spirit and scope of the invention.

What is claimed is:

1. An advertisement display method for providing advertisements from a display device, comprising:
acquiring advertisement information from a display right owner terminal which is endowed with an advertisement display right for displaying one or more advertisements, the advertisement information identifies an advertisement displayable by an advertisement display right;
deciding whether the advertisement identified by the acquired advertisement information is to be displayed on the display device, on a basis of one or more advertisement points to be consumed by a display of the advertisement on the display device;
displaying on the display device, summary data of the identified advertisement once it is decided to be displayed; and
displaying detailed data of the identified advertisement on the display device, and consuming the advertisement points of the identified advertisement as displayed, based on of a browsing request for details of the advertisement.

2. The advertisement display method according to claim 1, the consuming the advertisement points comprises:
consuming the advertisement points by taking into consideration consumption magnifications of the advertisement points corresponding at least to one of a time zone for displaying the advertisement and a sort of the detailed data to-be-displayed.

3. The advertisement display method according to claim 1, wherein the deciding whether the advertisement identified is to be displayed comprises:
deciding whether the identified advertisement corresponds to an advertisement ID is to be displayed and further on a basis of a place where the advertisement display device is installed.

4. The advertisement display method according to claim 1, further comprising:
storing an ID of the display right owner in association with the advertisement information of the identified advertisement once it is decided to be displayed; and
cumulating the display right owner ID associated with and the advertisement points consumed by the identified advertisement once displayed.

5. The advertisement display method according to claim 4, the cumulating comprises:
cumulating a consumption history of advertisement points consumed in a case where a browsing request source for the identified advertisement is not the display right owner of an acquisition source for the identified advertisement.

6. An advertisement display system comprising:
an advertisement point storage unit in which advertisement points are stored in association with advertisement information identifying each of a plurality of advertisements, the advertisement points are to be consumed with a display of an associated one of the advertisements on an advertisement display device;
a display propriety decision unit to decide whether the advertisement is to be displayed on the display device based on a) the advertisement information that indicates one of the plurality of advertisements displayable by an advertisement display right and that has been acquired from a display right owner terminal and b) the advertisement points that are stored in said storage unit;
a summary data display unit to display, on the display device, summary data of one of the plurality of advertisements that is decided by said display propriety decision unit to be displayed;
a detailed data display unit to display detailed data of the decided advertisement on the display device based on a browsing request for details of the advertisement displayed by said summary data display unit; and
a point consumption unit to consume one or more of the advertisement points stored in said advertisement point storage unit and corresponded to the display of the decided advertisement.

7. The advertisement display system according to claim 6, wherein:
said point consumption unit to consume one or more of the advertisement points by taking into consideration consumption magnifications of the advertisement points corresponding at least to one of a time zone for displaying the advertisement and a sort of the detailed data to-be-displayed.

8. The advertisement display system according to claim 6, wherein:
said display propriety decision unit to decide whether the decided advertisement to be displayed corresponds to an advertisement ID and further based on a place where the advertisement display device is installed.

9. The advertisement display system according to claim 6, further comprising:
a display right owner ID storage unit in which an ID of the display right owner is stored in association with the advertisement information of the decided advertisement to be displayed; and
a consumption history cumulation unit to cumulate the display right owner ID associated with and the advertisement points consumed for the decided advertisement for display.

10. The advertisement display system according to claim 9, wherein:
said consumption history cumulation unit to cumulate the consumption history in a case where a browsing request source for the advertisement is not the display right owner of an acquisition source for the decided advertisement for display.

11. A recording medium recording an advertisement display program to be executed to perform a process comprising:
acquiring advertisement information that indicates an advertisement displayable by an advertisement display right, from a display right owner terminal that is endowed with the advertisement display right for displaying the advertisement;
deciding whether the advertisement identified by the acquired advertisement information is to be displayed on the display device based on advertisement points of each of a plurality of advertisements that are to be consumed for displaying the each advertisement on the display device;
displaying on the display device, summary data of the identified advertisement once it is decided to be displayed; and
displaying detailed data of the identified advertisement on the display device, and consuming the advertisement points of the displayed advertisement, based on a browsing request for details of the advertisement;
wherein the advertisement display program is to be executed by a machine to perform the process.

12. The recording medium recording an advertisement display program according to claim 11, wherein the consuming the advertisement points comprises:
consuming the advertisement points by taking into consideration consumption magnifications of the advertisement points corresponding at least to one of a time zone for displaying the advertisement and a sort of the detailed data to-be-displayed.

13. The recording medium recording an advertisement display program according to claim 11, wherein:
the deciding decides whether or not the advertisement corresponding to an advertisement ID is to be displayed, further on the basis of a place where the advertisement display device is installed.

14. The recording medium recording an advertisement display program according to claim 11, further comprising:
storing an ID of the display right owner in association with the advertisement information of the advertisement that has been decided to be displayed; and
cumulating the display right owner ID associated and the advertisement points consumed, as to the displayed advertisement.

15. The recording medium recording an advertisement display program according to claim 14, wherein:
the cumulating cumulates the consumption history in a case where a browsing request source for the advertisement is not the display right owner of an acquisition source for the advertisement.
